(19) United States
(12) Patent Application Publication
(10) Pub. No.: US 2021/0086880 A1
(43) Pub. Date: Mar. 25, 2021

(54) TETHERED FLOATATION DEVICE AND RETRIEVAL SYSTEM

(71) Applicant: Jerry Hinz, South Bend, IN (US)

(72) Inventor: Jerry Hinz, South Bend, IN (US)

(21) Appl. No.: 17/027,339

(22) Filed: Sep. 21, 2020

Related U.S. Application Data
(60) Provisional application No. 62/903,212, filed on Sep. 20, 2019.

(51) Int. Cl. B63C 9/26; B66D 1/04

(52) U.S. Cl. CPC B63C 9/26; B66D 5/34; B66D 1/04

(57) ABSTRACT

A device for retrieving a stranded or drowning person can attach to a boat cleat and be used to draw the stranded person towards the boat. The device has a floatation portion that is thrown to the stranded person. The floatation portion has multiple latches for different sized persons. A winch portion pivots about a cleat adaptor, which attaches to the horns of a boat cleat using an aperture and a locking pin. The winch portion receives the cord that is attached to the floatation portion. An optional ice foot mates to the cleat adapter for retrieving a person who has fallen through ice.

### CROSS REFERENCE TO RELATED APPLICATIONS

This application claims the benefit of U.S. Provisional Application Ser. No. 62/903,212, filed Sep. 20, 2019, the disclosures of which are hereby incorporated by reference.

### BACKGROUND OF THE INVENTION

This present disclosure relates to retrieval of a person who has fallen into a body of water or needs assistance. Many attempts to solve this problem have been tackled with varying levels of success. The most memorable and common device is a ring buoy, commonly called a lifesaver. These are usually tied to a rope that can be used to retrieve the person that is in trouble. One large flaw with this type of device is the inability to accommodate for different sized or differently-abled individuals. It also requires person to hold on affirmatively, which can be difficult or impossible if the person is incapacitated. The rescuing person is required to have substantial upper body strength to pull a rope, especially to bring an incapacitated individual on to a boat or other vessel. An improved device is needed.

### SUMMARY OF THE INVENTION

The present disclosure describes a flotation and retrieval device for an incapacitated or partially incapacitated person who has fallen into a body of water. The device includes a ratcheting winch portion that can affix to a boat cleat and a buoyant tether portion that can retrieve an individual. The device is adaptable for different sized individuals, such as children. By using the ice cleat adapter, the device can be used to retrieve an individual who has fallen through thin ice. The retrieval system works by connecting the rope or cord to a floatation device, tossing or otherwise getting the floatation device to the stranded person, so they can attach it to themselves. In the event the person is incapacitated, a person in the water secures the floatation device and latches it around them. The cord is then connected to the ratcheting mechanism and the user begins to draw the person towards the boat. The lever action of the ratcheting mechanism allows the user to move the handle back and forth without worry that it will interfere with nearby devices or portions of the boat. Other attachments can be used with the device, such as an ice cleat for retrieving someone who has fallen through the ice.

### BRIEF DESCRIPTION OF THE DRAWINGS

FIG. 1 is a top overview of the system in use on a boat;

FIG. 2 is a perspective view of the winch and cleat adaptor;

FIG. 3 is a side view of the winch and cleat adaptor;

FIG. 4 is a side view of the winch and cleat adaptor as installed on a cleat;

FIG. 5 is an isometric view of the cleat adaptor;

FIG. 6 is a top view of the cleat adaptor;

FIG. 7 is a left side view of the cleat adaptor;

FIG. 8 is a right side view of the cleat adaptor;

FIG. 9 is a perspective view of the floatation device in FIG. 1;

FIG. 10 is a perspective view of a smaller sized floatation device; and

FIG. 11 is a perspective view of the winch, cleat adaptor, and ice adaptor.

### DESCRIPTION OF THE PREFERRED EMBODIMENT

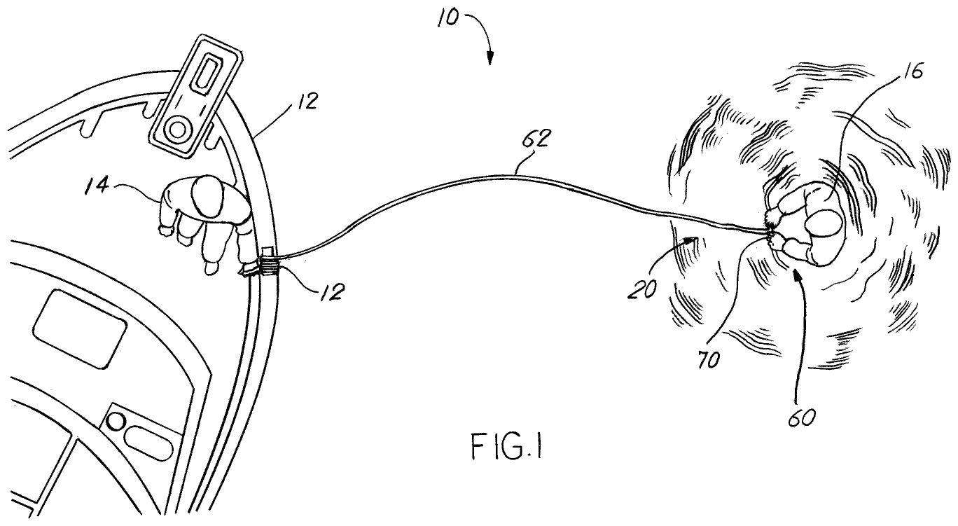

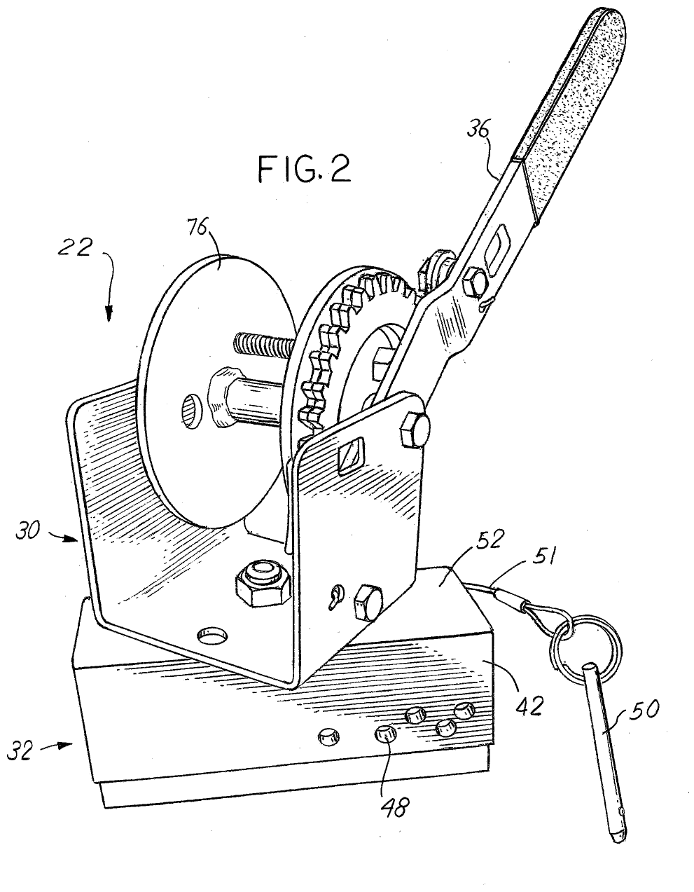

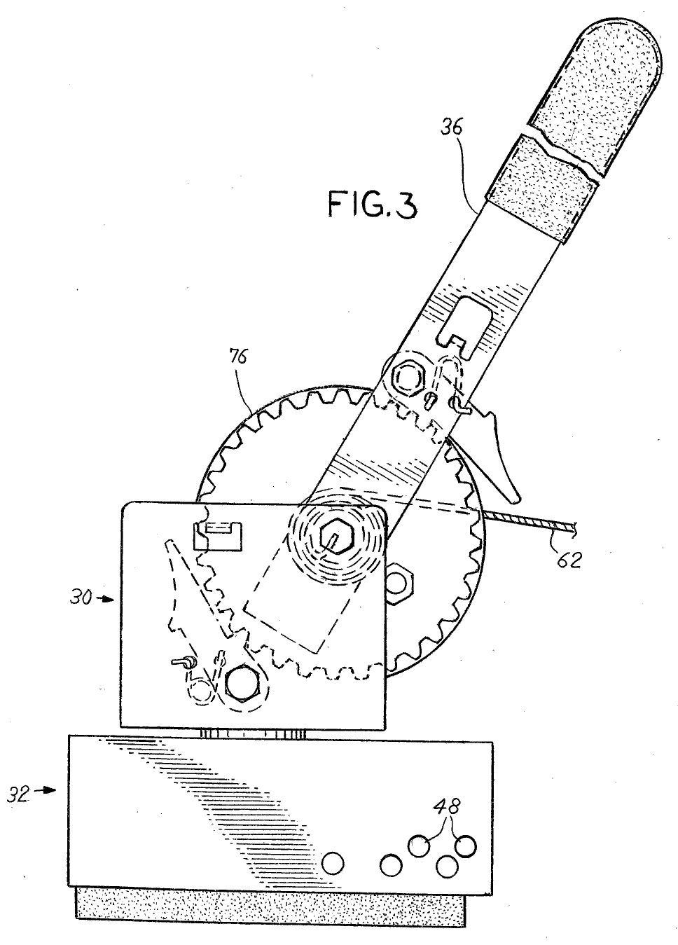

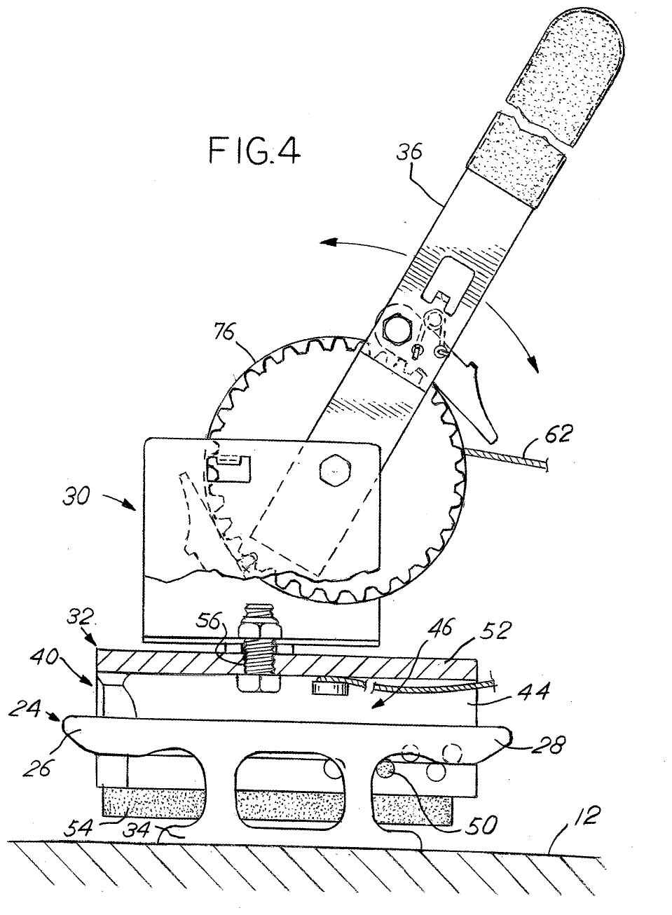

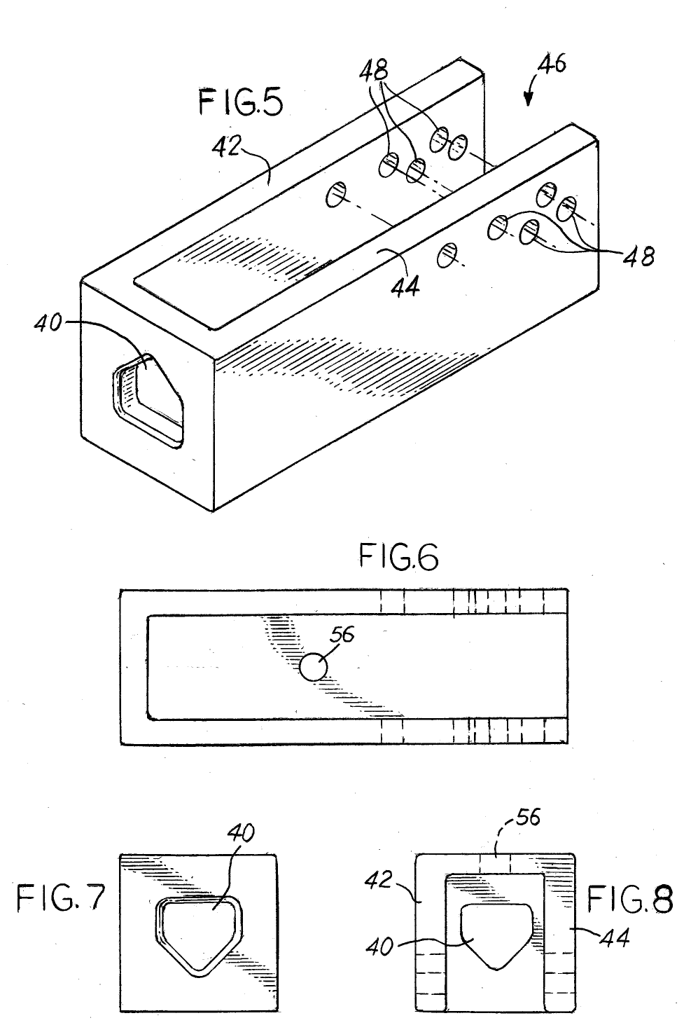

A rescue system 10 is shown in FIG. 1 as attached to a boat 12 and an operator 14 pulling a person 16 to safety. The system 10 has a floatation and tether portion 20 that attaches to the boat 12 and a winch portion 22 that secures the person 16. The winch portion 22 attaches to a cleat 24, shown in FIG. 6.

The winch portion 22 has a retraction mechanism 30 and a cleat adaptor 32. The retraction mechanism is shown as a manually operated winch, but other devices are contemplated, such as electrically operated winch, hand crank, roller, ratchet, or other device that can pull on a cable, strap, or cord. The cleat adaptor 32 is designed to fit over and affix to various sizes of boat cleats 24. Because boat cleats 24 are used to tie a boat to a pier or dock, they are securely affixed to the boat 12, providing a convenient and secure point for the cleat adaptor 32. Cleats 24 have horns 26, 28 that are spaced from a mounting flange 34. The cleat adaptor 32 has a horn aperture 40 on one end that receives one of the horns 26. This is shown in FIG. 6. The cleat adaptor 32 has parallel walls 42, 44, with a cleat channel 46 located between them. On the walls 42, 44 located on an end opposite the horn aperture 40, are a series of locking holes 48. The locking holes 48 receive a pin 50 that extends across the cleat channel 46 to lock in the other horn 28. The pin 50 is tethered 51 to prevent it from being misplaced. The user 14 selects the closest locking hole 48 that holds the cleat 24 securely inside the cleat channel 46. The cleat adaptor 32 is shown with an optional padded bottom surface 54 to prevent marring, scratching, or other damage from the cleat adaptor 32 when affixed to the cleat 24.

The walls 42, 44 are connected at a top wall 52 that mounts the retraction mechanism 30 through a mounting aperture 56. The mounting aperture 56 allows the retraction mechanism 30 to swivel. Swiveling the retraction mechanism 30 with respect to the cleat adaptor 32 prevents binding. The retraction mechanism 30 uses a lever 36 that moves back and forth to retract, instead of a handle that rotates 360 degrees. When the winch portion 22 is affixed to a boat 12, there are frequently other components, such as railing, trim, or other components that would prevent a full rotation. By using the limited travel of the lever retraction mechanism 30, interference with the boat hull or other components is reduced or eliminated. It is contemplated that the retraction mechanism could be a hand crank or electric winch of some sort, provided no part would extend beyond the bottom, where it could interfere with the components on the boat 12.

Instead of the retraction mechanism 30, the cleat adaptor 32 can be used to attach an assortment of other devices. The top wall 52 can be used to affix other devices, such as a grill, flag poles, fishing pole holders, umbrella holder, or anything that would need to be attached to a boat with a cleat. It is contemplated that the features of the cleat adaptor 32 can be integrated into the aforementioned devices or components.

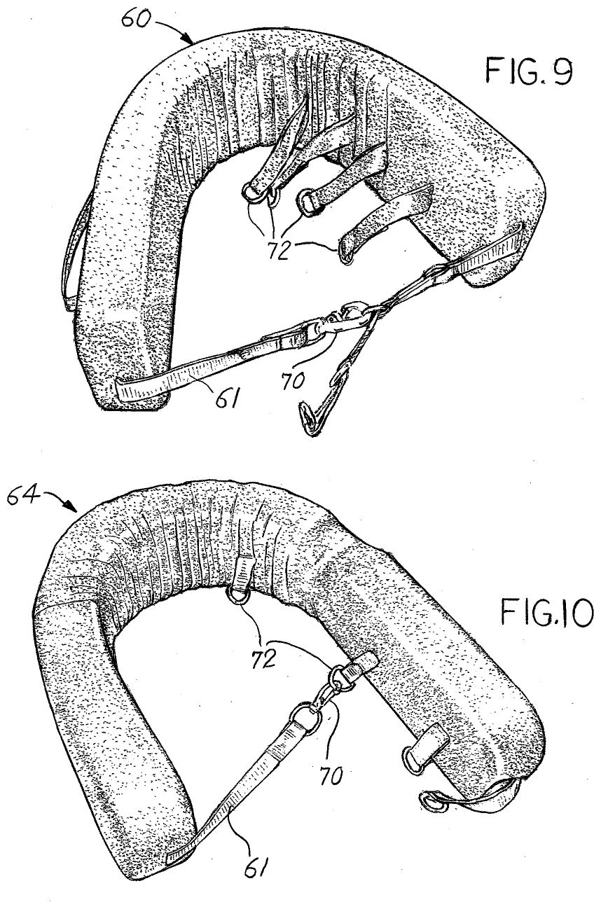

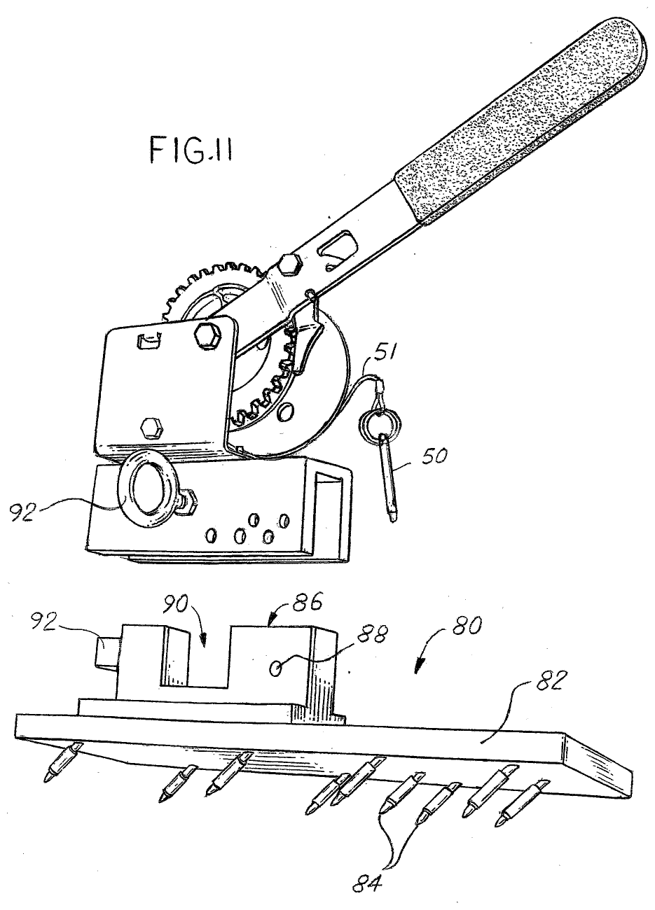

Turning now to the tether portion 20, there is a floatation end 60, 64 attached to a rope 62 or cable or is separable from the rope 62 with its own integral cable or rope 61. Floatation end 60 is larger and designed for adults. Floatation end 64 is smaller and can be used with children or pets. As shown in FIGS. 9 and 10, the rope or cable 61 may be separate from rope 62 to allow convenient storage and allow different devices to be attached. The flotation end 60, 64 is buoyant and can be in three connected segments or one flexible loop of buoyant material. Running through the floatation end 60, 64 is the rope 62 that terminates at a latch 70. The rope 62 is fixed or constrained inside the floatation end 60, 64. The latch 70 extends beyond the buoyant material enough for access by the user 14 or person 16. The latch 70 is designed to fit over the rope 62 to form a loop to surround the person 16. The flotation end 60, 64 may also contain a series of rings 72 or loops for the latch 70 to attach. The rings 72 are securely affixed to the segments and/or rope 62 to provide a secure attachment point.

To install the winch portion 22 with the cleat adaptor 32, the user takes the horn 26 of the cleat 24 and inserts it through the horn aperture 40. The installation shown in FIG. 6 shows the horn 26 partially inserted through the horn aperture 40. The user moves the horn 26 as far as possible through the horn aperture 40 and then locates the closest locking hole 48 that can receive the pin 50 underneath the other horn 28. This prevents the cleat adaptor 32 from becoming detached with movement. For the first time the user has installed the cleat adaptor 32, the user would mark the preferred locking hole 48 with a paint marker or other indelible marking device. This allows a quick and convenient reference for the next user. This is particularly important when someone has fallen into the water and needs to be retrieved. In this situation, time is of the essence and the user may not be thinking clearly. This could result in the user selecting the incorrect locking hole 48, which may leave the cleat adaptor 32 loose and become detached during use.

To deploy the tether portion 20, the user 14 would first thread the end of the rope 62 opposite the latch 70 through the drum 76 or otherwise attach it to the retraction mechanism 30. The user 14, or another operator, would then throw or swim the flotation end 60 of the tether portion 20 to the person 16. Depending on the size and ability of the person 16, the user 14 may connect the latch 70 to the rope 62 to form a “lasso.” Pulling on the rope 62 would cause the latch 70 to slide down the rope 62 and tighten the flotation end 60 around the person. If the person 16 is smaller or has different abilities, the user may connect the latch 70 to one of the rings 72.

Other devices allow the tether and winch portions 20, 22 to be used on other things besides boat cleats. For example, an ice adapter 80 is shown in FIG. 11 that allows rescue of a stranded person who has fallen through thin ice. The ice adapter 80 has a foot portion 82 and a cleat portion 86. The cleat portion 86 is designed to mate to the cleat adapter 32 with a horn portion 92 being received by the horn aperture 40 with the remainder residing in the cleat channel 46. A locking hole 88 aligns with one of the locking holes 48 to receive the locking pin 50. The foot portion 82 has an array of cleats 84 that protrude at an angle that are pointed in a direction toward the horn portion. The oblique angle provides additional traction that pulls the ice adapter 80 further into the ice as the user attempts to pull a stranded person towards the retraction mechanism 30. In the event that no ice or boat cleat are available at the time a person needs rescue, eyelets 92 are shown on the sides of the cleat adapter 32 in FIG. 11. The eyelets 92 can be used to attach the cleat adapter 32 to a vehicle, tree, or other stationary object. The cleat portion 86 includes a clearance notch 90 for the inside features of the eyelets 92 and bolt that holds the retraction mechanism 30 to the cleat adapter 32.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A tethered flotation and retrieval system for affixing to a cleat having horns, said system comprising:
a tether portion being a rope having a buoyant flotation portion located on one end and terminating at a latch, said flotation portion having rings affixed thereto,
a winch portion having a cleat adapter affixed to a retraction mechanism, said cleat adapter having parallel walls forming a cleat channel, said cleat adapter having a horn aperture, said cleat adapter having apertures extending through said parallel walls to receive a pin, said retraction mechanism for receiving said rope, said retraction mechanism for retracting said rope to pull said flotation portion toward said winch portion; and
when said cleat is located in said cleat channel and one of said horns is located in said horn aperture, said pin extendable through said apertures to constrain said cleat to said cleat adapter when said pin extends underneath the other of said horns.

2. A cleat adaptor comprising:
said cleat adapter having parallel walls forming a cleat channel, said cleat adapter having a horn aperture, said cleat adapter having apertures extending through said parallel walls to receive a pin; and
when said cleat is located in said cleat channel and one of said horns is located in said horn aperture, said pin extendable through said apertures to constrain said cleat to said cleat adapter when said pin extends underneath the other of said horns.
